(19) United States
(12) Patent Application Publication
(10) Pub. No.: US 2025/0136075 A1
(43) Pub. Date: May 1, 2025

(54) VEHICLE BRAKING DEVICE

(71) Applicant: DENSO CORPORATION, Kariya-city (JP)

(72) Inventor: YUSUKE SHIBATA, Kariya-city (JP)

(21) Appl. No.: 19/008,293

(22) Filed: Jan. 2, 2025

Related U.S. Application Data
(63) Continuation of application No. PCT/JP2023/024618, filed on Jul. 3, 2023.

(30) Foreign Application Priority Data
Jul. 6, 2022 (JP) 2022-108773

(51) Int. Cl. B60T 8/58; B60T 8/171; B60T 8/172

(52) U.S. Cl. CPC B60T 8/58; B60T 8/171; B60T 8/172; B60T 2220/04; B60T 2250/04

(57) ABSTRACT

A vehicle braking device with electric brakes includes a braking force controller. This controller adjusts braking forces based on an external command. The electric brakes show hysteresis characteristics: braking force rises with increasing current along a positive efficiency line and holds steady when current drops from a turning value to a holding threshold. Further current decrease leads to a reduction in braking force along an inverse efficiency line. The actual braking force has an increasing period when it follows the positive efficiency line and a holding period when it stays constant as current decreases to the holding threshold. If the vehicle does not meet an exclusion requirement and the required braking force is rising, the controller switches from the increasing period to the holding period when the actual braking force matches the target braking force. It switches back to the increasing period when the difference between the actual and target braking forces reaches a predetermined threshold.

### CROSS REFERENCE TO RELATED APPLICATIONS

The present application is a continuation application of International Patent Application No. PCT/JP2023/024618 filed on Jul. 3, 2023, which designated the U.S. and claims the benefit of priority from Japanese Patent Application No. 2022-108773 filed on Jul. 6, 2022. The entire disclosures of all of the above applications are incorporated herein by reference.

### TECHNICAL FIELD

The present disclosure relates to a vehicle braking device.

### BACKGROUND

Conventional electric brake systems for vehicles have ability to reduce power consumption during braking.

According to at least one embodiment, a vehicle braking device is designed for a vehicle with electric brakes. These brakes are provided on respective wheels and generate braking force on the corresponding wheels. The device includes a braking force controller that controls braking forces generated by the electric brakes based on a required braking force commanded from an external source.

In each of the electric brakes, a relationship between an electric current and braking force exhibits hysteresis characteristics. The hysteresis characteristics indicate that the braking force increases along a positive efficiency line when the electric current increases. When the electric current decreases from a turning value, which is a point where the current changes from increasing to decreasing, to a holding threshold, the braking force is held constant. The braking force then decreases along an inverse efficiency line when the electric current decreases from the holding threshold.

A period during which the actual braking force, which is the force actually output by the electric brake, increases along the positive efficiency line is termed the increasing period. A period during which the actual braking force is held constant while the current decreases from the turning value to the holding threshold is termed the holding period.

Under a condition that the vehicle does not meet an application exclusion requirement and the required braking force is increasing, the braking force controller operates as follows. When the actual braking force increases and reaches a target braking force, which is set based on the required braking force, the controller switches from the increasing period to the holding period. Conversely, when a target difference between the actual braking force and the target braking force reaches a predetermined target difference threshold, the controller switches from the holding period to the increasing period.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a configuration of a vehicle with which a vehicle braking device of the present embodiment is equipped.

FIG. 2 is a diagram illustrating hysteresis characteristics between an electric current and a braking force of an electric brake.

FIG. 3 is a diagram illustrating issues of conventional technology.

FIG. 4 is a time chart illustrating a switching process according to the first embodiment.

FIG. 5 is an enlarged view of sections [I] to [IV] in FIG. 4.

FIG. 6 is a flowchart of the switching process.

FIG. 7 is a flowchart of determination of whether an application exclusion requirement is satisfied.

FIG. 8 is a time chart illustrating a switching process according to a second embodiment.

FIG. 9 is a time chart illustrating a switching process according to a third embodiment.

FIG. 10 is a time chart illustrating a switching process according to a fourth embodiment.

FIG. 11 is a time chart illustrating a switching process according to a fifth embodiment.

FIG. 12 is a time chart illustrating the switching process according to a modification of the fifth embodiment.

FIG. 13 is a time chart illustrating a switching process according to a sixth embodiment.

### DETAILED DESCRIPTION

To begin with, examples of relevant techniques will be described.

Conventionally, in an electric brake device for a vehicle, a technique for reducing power consumption during braking has been known. An electric brake device according to a comparative example performs braking by converting an output of a motor into a pressing force. When motor torque is increased, the pressing force increases due to positive efficiency operation, and when the motor torque is decreased, hysteresis characteristics is shown where the pressing force does not change until it falls below a certain torque. The electric brake device aims to reduce an electric current of the motor by limiting a ratio of time of the positive efficiency operation within a predetermined time to a predetermined value or less.

In the electric brake device of the comparative example, a time ratio between an increasing period during which the braking force is increased by the positive efficiency operation and a holding period during which the braking force is held without the positive efficiency operation is managed to be a predetermined value. Since the increasing period and the holding period alternate every predetermined time regardless of a change amount in a required braking force during the holding period, a difference between an actual braking force and the required braking force during the holding period cannot be managed. The actual braking force and the required braking force are capable of diverging when the required braking force increases rapidly during the holding period, causing driver's brake feeling to deteriorate.

In contrast to the comparative example, according to a vehicle braking device, deterioration in feeling due to a discrepancy between an actual braking force and a required braking force can be avoided and an electric current of an electric brake can be reduced.

According to one aspect of the present disclosure, a vehicle braking device is designed for a vehicle with electric brakes. These brakes are provided on respective wheels and generate braking force on the corresponding wheels. The device includes a braking force controller that controls braking forces generated by the electric brakes based on a required braking force commanded from an external source.

In each of the electric brakes, a relationship between an electric current and braking force exhibits hysteresis characteristics. The hysteresis characteristics indicate that the braking force increases along a positive efficiency line when the electric current increases. When the electric current decreases from a turning value, which is a point where the current changes from increasing to decreasing, to a holding threshold, the braking force is held constant. The braking force then decreases along an inverse efficiency line when the electric current decreases from the holding threshold.

A period during which the actual braking force, which is the force actually output by the electric brake, increases along the positive efficiency line is termed the increasing period. A period during which the actual braking force is held constant while the current decreases from the turning value to the holding threshold is termed the holding period.

Under a condition that the vehicle does not meet an application exclusion requirement and the required braking force is increasing, the braking force controller operates as follows. When the actual braking force increases and reaches a target braking force, which is set based on the required braking force, the controller switches from the increasing period to the holding period. Conversely, when a target difference between the actual braking force and the target braking force reaches a predetermined target difference threshold, the controller switches from the holding period to the increasing period.

As a result, deterioration in feeling caused by a discrepancy between the actual braking force and the required braking force, and heat generated the energization of the electric brake can be reduced.

Hereinafter, multiple embodiments of a vehicle braking device will be described with reference to the drawings. The vehicle braking device of the present embodiment is equipped to a vehicle in which electric brakes that generate braking forces on corresponding wheels are provided on respective wheels. The vehicle braking device includes a braking force controller that controls a braking force generated by each of the electric brakes. The following first to sixth embodiments are collectively referred to as “present embodiment”. In the first to sixth embodiments, a configuration of the vehicle braking device is the same, and a processing by the braking force controller is different.

### First Embodiment

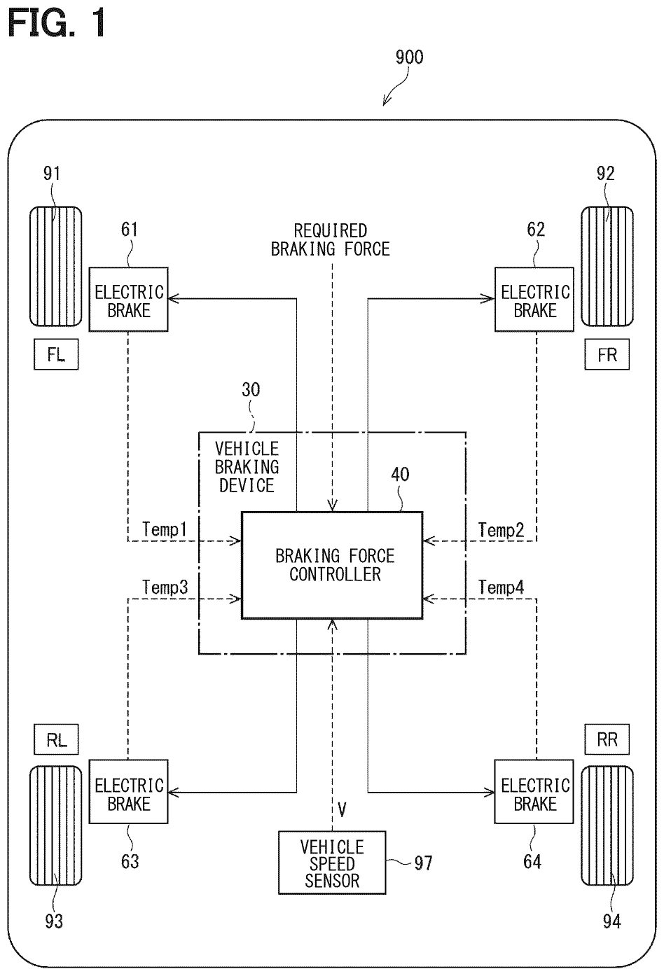

Common matters of the respective embodiments and the first embodiment will be described with reference to FIGS. 1 to 7. First, with reference to FIG. 1, a configuration of a vehicle 900 to which a vehicle braking device 30 is equipped will be described. The vehicle 900 is a four-wheel vehicle having two rows of left and right pairs of wheels 91, 92, 93, 94 in a front-rear direction. In the present specification, the wheels 91, 92 are also referred to as front row left and right wheels FL, FR. The wheels 93, 94 are also referred to as rear row left and right wheels RL, RR.

Electric brakes 61, 62, 63, 64, in this example is four, are provided corresponding to each of the wheels 91, 92, 93, 94. Hereinafter, four consecutive reference numerals will be appropriately abbreviated to “wheels 91 to 94” and “electric brakes 61 to 64”. The same shall apply to “electric brake temperatures Temp1 to Temp4” described below.

Each of the electric brakes 61 to 64 generates a braking force on each of the corresponding wheels 91 to 94 by pressing a friction pad against a brake rotor by a positive operation of an electric actuator including a motor or the like. The braking force is reduced to zero when the friction pad is separated from the brake rotor by an operation of the electric actuator. Since this mechanical structure of the electric brakes 61 to 64 is a well-known technique, a detailed description thereof will be omitted.

The vehicle braking device 30 includes a braking force controller 40 that controls the braking force generated by each electric brake 61 to 64 on the corresponding wheel 91 to 94 based on a required braking force commanded from outside. More specifically, the required braking force is commanded by the driver's brake operation, a braking signal from a driving assistance device, or the like. The braking force controller 40 individually controls an electric current to be supplied to each of the electric brakes 61 to 64 and a supply timing of the electric current.

As shown in the dashed line in FIG. 1, the braking force controller 40 may also obtain vehicle speed V from a vehicle speed sensor 97 and the electric brake temperatures Temp1 to Temp4 from each electric brake 61 to 64. The electric brake temperatures Temp1 to Temp4 are detected by, for example, a temperature sensor. Alternatively, the electric brake temperatures Temp1 to Temp4 may be calculated based on an integrated power value of each electric brake 61 to 64 when effects of outside temperature and vehicle exhaust heat are equivalent in each electric brake 61 to 64.

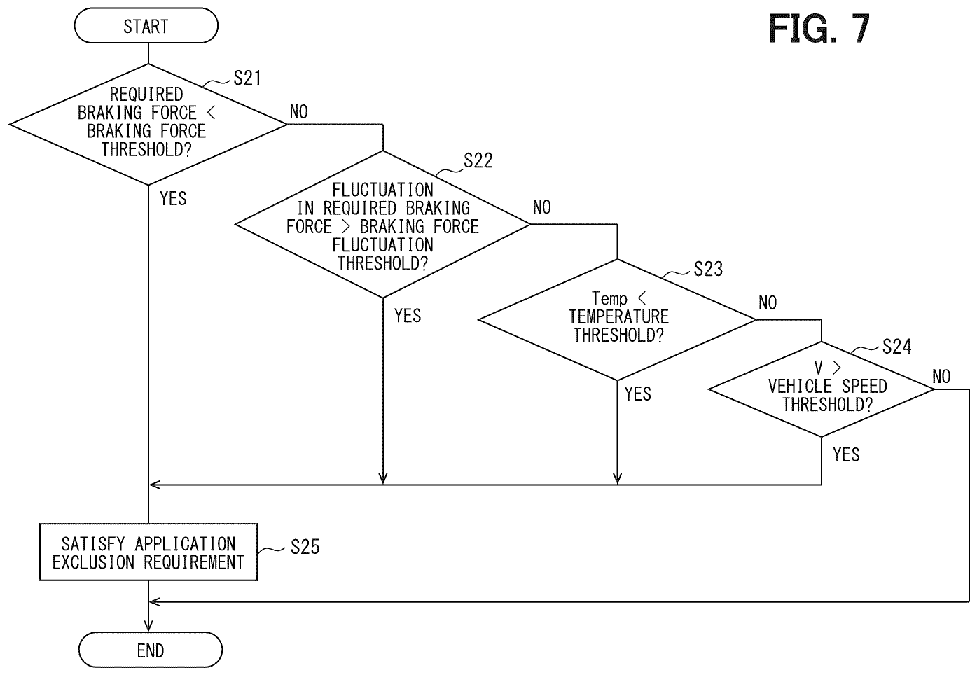

The vehicle speed V and the electric brake temperatures Temp1 to Temp4 are also mentioned in descriptions of an application exclusion requirement with reference to FIG. 7. The braking force controller 40 does not need to obtain the vehicle speed V or the electric brake temperatures Temp1 to Temp4 when the braking force controller 40 not used the application exclusion requirement.

Next, a relationship between the electric current supplied to the electric brakes 61 to 64 and the braking force will be described with reference to FIG. 2. As shown in FIG. 2, the relationship between the electric current of the electric brakes 61 to 64 and the braking force has hysteresis characteristics. For example, an actuator of the electric brake is a motor, the actuator may use an electric linear actuator.

Arrows in FIG. 2 indicate a direction of hysteresis. The braking force increases along a positive efficiency line when the electric current increases in a section (A). A value at which the electric current changes from an increase to a decrease is referred to as a “turning value Iconv”. A process of electric current decrease is divided into two sections (B) and (C). When the electric current decreases from the turning value Iconv to a holding threshold Icr in the section (B), the braking force is held at a constant holding braking force Br_H. When the electric current decreases from the holding threshold Icr in the section (C), the braking force decreases along an inverse efficiency line.

When the electric current turns from decreasing to increasing, as indicated by arrow (D) in FIG. 2, the braking force at the point is maintained and moves to the section (A) along the positive efficiency line. In addition, the turning value Iconv and the holding braking force Br_H are not fixed values, but change each time according to an increase or decrease in the electric current. In other words, as shown by dashed arrows in FIG. 2, each alternation between increasing and decreasing currents moves back and forth on a constant braking force line between the positive efficiency line and the inverse efficiency line. In the section (A), power consumption is high, but in the section (B), the electric current can be reduced while maintaining the braking force by using a frictional force.

Hereafter, the braking force that is actually output by the electric brakes 61 to 64 is called an “actual braking force”. A period during which the actual braking force is increased along the positive efficiency line is defined as an “increasing period”. A period during which the actual braking force is held constant while decreasing the electric current from the turning value Iconv to the holding threshold lcr is defined as a “holding period”. The braking force controller 40 controls energization of the electric brakes 61 to 64 at operating points on the positive efficiency line during the increasing period. The braking force controller 40 also controls the energization of the electric brakes 61 to 64 at operating points on the inverse efficiency line during the holding period.

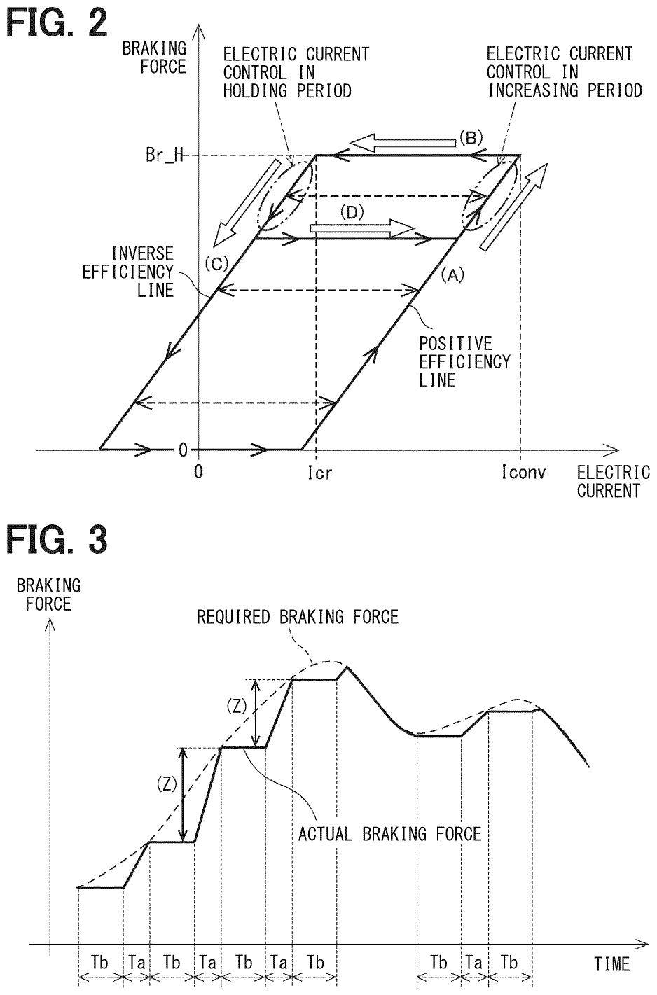

FIG. 3 shows variation of a pressing force, or the braking force, with respect to time based on the comparative example. In an electric brake device of the comparative example, a time ratio between an increasing period Ta during which the braking force is increased by the positive efficiency operation and the holding period Tb during which the braking force is held without the positive efficiency operation is managed to be a predetermined value. Since the increasing period Ta and the holding period Tb alternate every predetermined time regardless of a change amount in the required braking force during the holding period, a difference between the actual braking force and the required braking force during the holding period Tb cannot be managed. As shown in part (Z), when the required braking force increases rapidly during the holding period Tb, the actual braking force and the required braking force will diverge, causing the driver's brake feeling to deteriorate.

Therefore, in contrast to the comparative example, according to the present embodiment, the deterioration in feeling due to a discrepancy between the actual braking force and the required braking force in the holding period can be avoided and the electric current on the electric brake can be reduced. Therefore, the braking force controller 40 assumes, in principle, that “the vehicle does not meet the prescribed application exclusion requirement and the required braking force commanded by the outside is increasing”, and implements a “switching process” to switch between the increasing period and the holding period according to prescribed rules.

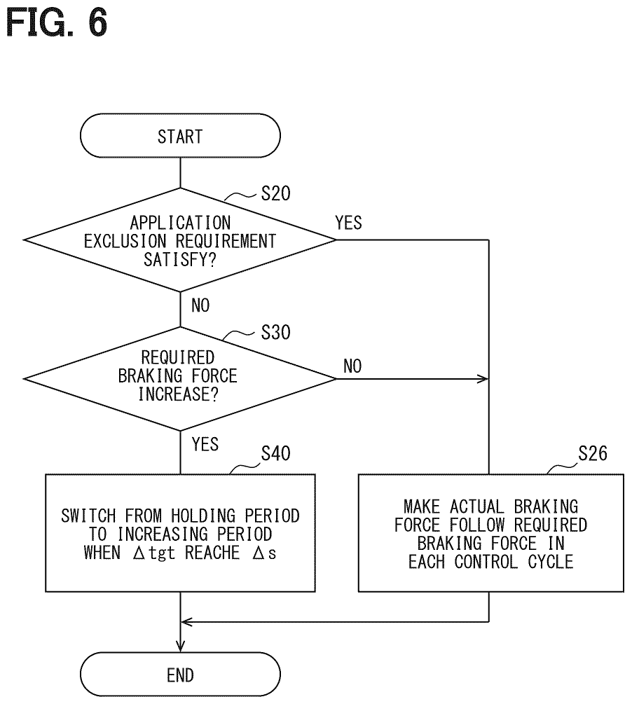

As an exception, however, if the vehicle meets the application exclusion requirement, or if the required braking force is constant or decreasing, the braking force controller 40 does not perform the switching process. The application exclusion requirement will be described later with reference to FIGS. 6 and 7.

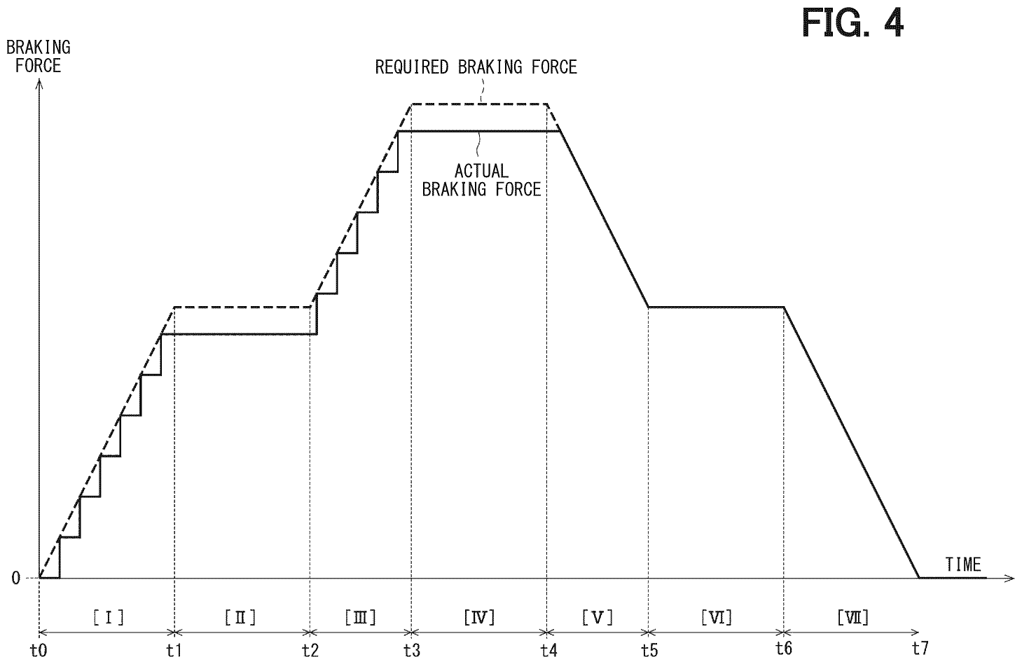

Next, the switching process according to the present embodiment is explained. First, FIG. 4 shows a change model in the required braking force. In the change model, the required braking force increases in two steps from zero to a maximum value and then decreases in two steps from the maximum value to zero. A horizontal axis in FIG. 4 shows an entire area divided into seven sections. As shown by dashed lines, the required braking force increases in section [I] from time point t0 to t1, is constant in section [II] from time point t1 to t2, and increases again in section [III] from time point t2 to t3. In section [IV] from time point t3 to t4, the required braking force is constant at the maximum value. Furthermore, the required braking force decreases in section [V] from time point t4 to t5, is constant in section [VI] from time point t5 to t6, and decreases in section [VII] from time point t6 to t7.

In response to the required braking force, the actual braking force by the switching process of the first embodiment changes as shown in a solid line. First, in common with each embodiment, when the required braking force is reduced in sections [V] to [VII], the switching process is not performed, and the actual braking force changes following the required braking force. Thereafter, references to when the required braking force is reduced are omitted.

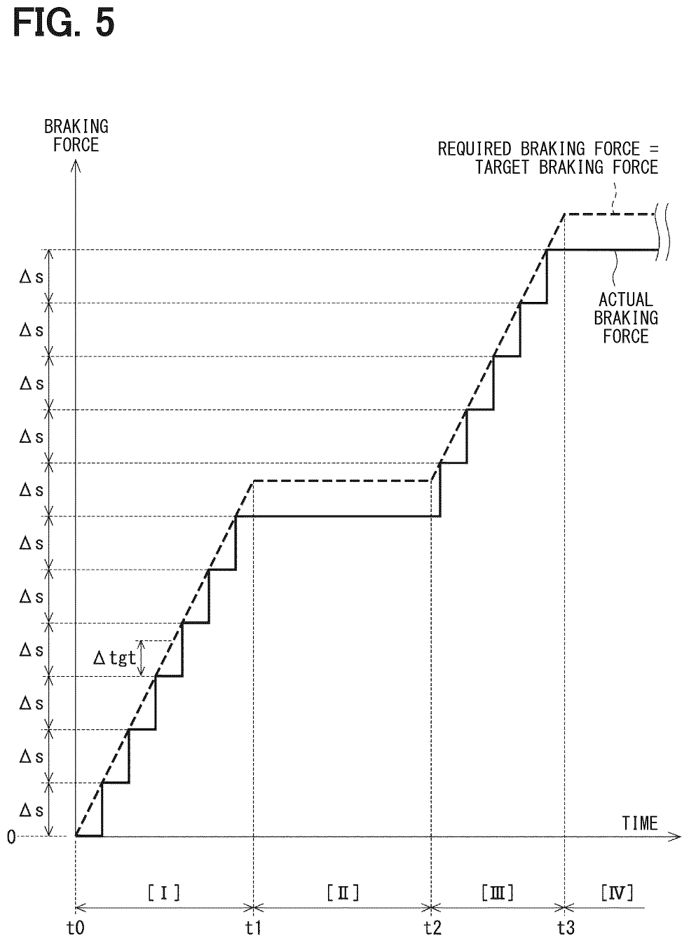

On the other hand, referring to FIG. 5, which expands sections [I] to [IV] where the required braking force increases intermittently, the switching process of the first embodiment is explained. The braking force controller 40 sets an internal control target value, a “target braking force,” based on the required braking force commanded from the external. In the first embodiment, the “target braking force set based on the required braking force” is set to the same value as the required braking force. In other words, the required braking force is equal to the target braking force.

A difference between the actual braking force (the solid line) and the target braking force (the dashed line) is defined as a “target difference Δtgt”. In the first embodiment, a target difference threshold Δs, against which the target difference Δtgt is contrasted, is set to a fixed value. This type of target difference threshold Δs is hereafter referred to as a “fixed-type target difference threshold”. The symbol “Δs” is derived from a ‘stationary’.

The braking force controller 40 switches from the increasing period to the holding period when the actual braking force increases and reaches the target braking force, that is, when the target difference Δtgt becomes zero. The braking force controller 40 switches from the holding period to the increasing period when the target difference Δtgt reaches the target difference threshold Δs. Therefore, in sections [I] and [III] where the required braking force increases monotonically, the actual braking force increases in a staircase-like manner.

The braking force controller 40 does not manage the time ratio between the increasing period and the holding period as in the comparative example, but switches from the holding period to the increasing period when the target difference Δtgt reaches the target difference threshold Δs in the holding period. As a result, the deterioration in feeling caused by the discrepancy between the actual braking force and the electric current of the electric brake, and heat generated the energization of the electric brake can be reduced.

Referring to a flowchart in FIG. 6, the switching process according to the present embodiment is explained. In the following flowchart, a symbol “S” indicates a step. In step S20, it is determined whether the vehicle 900 satisfies the application exclusion requirement. In situations where benefit of electric-current reduction is small, or in situations where responsiveness to the required braking force is more important than the electric-current reduction, it may be better not to perform the switching process. A requirement for determining such a case is defined as the application exclusion requirement. A specific example of the application exclusion requirement will be described later with reference to FIG. 7.

When “NO” in step S20, that is, the application exclusion requirement is not met, then in step S30, it is determined whether the required braking force is currently increasing. When “YES” in step S20 or “NO” in step S30, the braking force controller 40 controls the energization of the electric brakes 61 to 64 to make the actual braking force follow the required braking force in each control cycle as a normal control in step S26.

The term “following the actual braking force to the required braking force” is generally interpreted to mean following at each control cycle. In other words, on a micro time axis, the actual braking force increases in a staircase-like manner with discrete values at each control cycle in the normal control. In contrast, one holding period of the switching process of the present embodiment is sufficiently long compared to the control cycle. The benefit of the electric-current reduction can be achieved because one holding period is secured for a certain amount of time. Therefore, the switching process of the present embodiment is clearly different in technical concept from the normal control performed at each control cycle.

When “NO” in step S20 and “YES” in step S30, the braking force controller 40 switches from the holding period to the increasing period when the target difference Δtgt reaches the target difference threshold Δs in step S40. A symbol for the target difference threshold is replaced by “Δp” in the second embodiment.

An example of whether the application exclusion requirement is satisfied will be described with reference to the flowchart of FIG. 7. In this example, whether the application exclusion requirement is satisfied is sequentially determined in steps S21 to S24. It is determined that the application exclusion requirement is satisfied in step 25 when it is determined as “YES” in at least one of steps S21 to S24.

In step S21, it is determined whether the required braking force is less than a predetermined braking force threshold. Since there is little merit in reducing the electric current in a low current range, it is sufficient to energize the electric brakes 61 to 64 so that the actual braking force follows the required braking force at each control cycle. In addition, as a precondition for determination of a sudden braking in step S22, a maximum electric current flows without using the braking force holding section in the low current region, so that an occurrence of a response delay can easily be avoided until the sudden braking is determined.

In step S22, it is determined whether fluctuation in the required braking force is greater than a predetermined braking force fluctuation threshold. In a case of “YES” in step S22, that is, in a case of the sudden braking, a response speed is prioritized over the electric-current reduction. It may therefore be desirable for the actual braking force to follow the required braking force with a high degree of responsiveness.

In step S23, it is determined whether the temperatures Temp1 to Temp4 of the electric brakes 61 to 64 are less than a predetermined temperature threshold. When “YES” in step S23, benefit of heat reduction through the electric-current reduction is small. In step S24, it is determined whether the vehicle speed V is higher than a predetermined vehicle speed threshold. When “YES” in step S24, the actual braking force may follow the required braking force in a highly responsive manner.

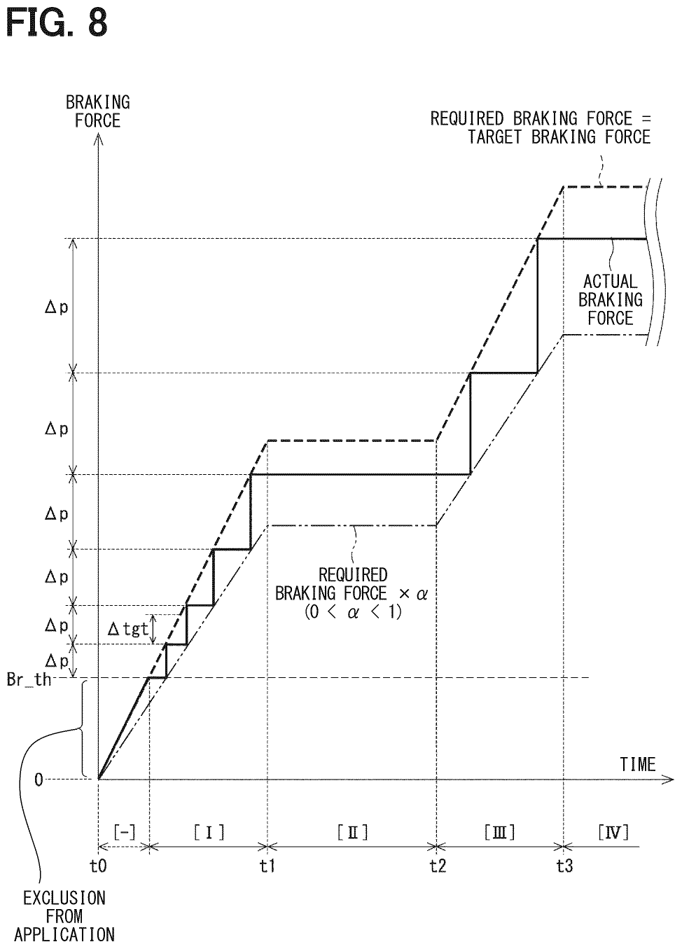

Each of the embodiments with a different switching configuration from the holding period to the increasing period compared to the first embodiment is then described in turn with reference to the respective time charts in FIGS. 8 to 13, which correspond to FIG. 5. In FIGS. 8 to 13, dashed lines indicating the required braking force are the same as in FIG. 5. In the second and fifth embodiments, as in the first embodiment, the required braking force is the target braking force. In the third, fourth, and sixth embodiments, an upper limit value greater than the required braking force for switching is the target braking force, as described below.

### Second Embodiment

In the second embodiment shown in FIG. 8, a target difference threshold Δp is set to a value that correlates to a current required braking force. In a typical example, the target difference threshold Δp is set to a value proportional to the current required braking force. The symbol “Δp” is derived from “proportional”. In FIG. 8, the lower limit value calculated by “required braking force*α” with α (0<α<1) as a proportional constant is represented by a two-dot chain line. A difference between the lower limit value and the required braking force at a switching time point is the target difference threshold Δp. The braking force controller 40 switches from the holding period to the increasing period when the target difference Δtgt reaches the target difference threshold Δp during the holding period. As a result, in the second embodiment, the actual braking force can be controlled so that the target difference Δtgt is within a predetermined ratio to the required braking force.

When the target difference threshold Δp is proportional to the required braking force, the target difference threshold Δp is a minute value close to zero in a section immediately after the required braking force starts up from zero, which may cause hunting of the control. To prevent this, for example, it is preferable not to perform the switching process in a rising section [-] in FIG. 8 due to the application exclusion requirement of “the required braking force is less than the predetermined braking force threshold Br_th” shown in step S21 in FIG. 6. Alternatively, a fixed target difference threshold Δs may be used when the required braking force is less than the braking force threshold Br_th, and switched to the target difference threshold Δp proportional to the required braking force when the required braking force reaches the braking force threshold Br_th.

The target difference threshold Δp in the second embodiment is not limited to a simple proportionality, but may be defined, for example, as a linear function expressed as sum of a proportional term and a constant term of the required braking force, or as a quadratic function including a square term of the required braking force. Including these examples, the target difference threshold Δp according to the second embodiment is referred to as the “target difference threshold of the required braking force correlation formula”.

### Third Embodiment

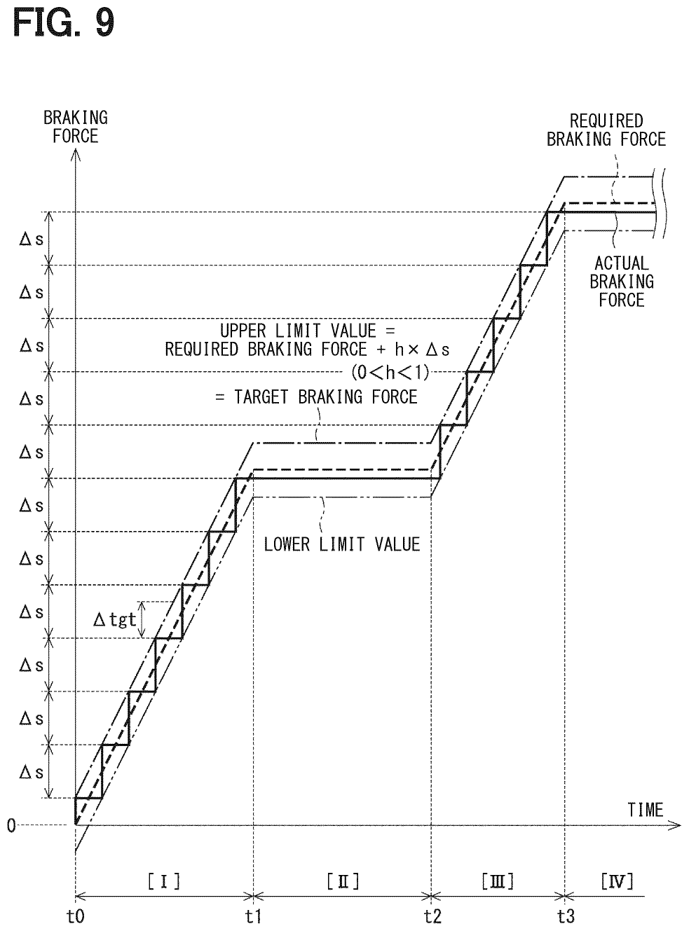

In the third embodiment shown in FIG. 9, the braking force controller 40 sets an upper limit value (dash-dot-dash line) and a lower limit value (two-dot chain line) with a difference equivalent to the fixed target difference threshold Δs, up or down across the required braking force. The braking force controller 40 controls the actual braking force between the lower limit value and the upper limit value with the upper limit value as the target braking force.

For example, a value obtained by adding one-half of the target difference threshold Δs to the required braking force is set as the upper limit value. In this case, a value obtained by subtracting one-half of the target difference threshold Δs from the required braking force is the lower limit value, and the upper and lower limit values are set equally above and below the required braking force. The actual braking force in FIG. 9 is offset from the actual braking force in FIG. 5 by one-half of the target difference threshold Δs, and an average value of the actual braking force approaches the required braking force. However, the upper and lower limit values may be set unequally up and down across the required braking force. When 0<h<1, it is generally expressed as “upper limit value=required braking force+h*Δs=target braking force”.

### Fourth Embodiment

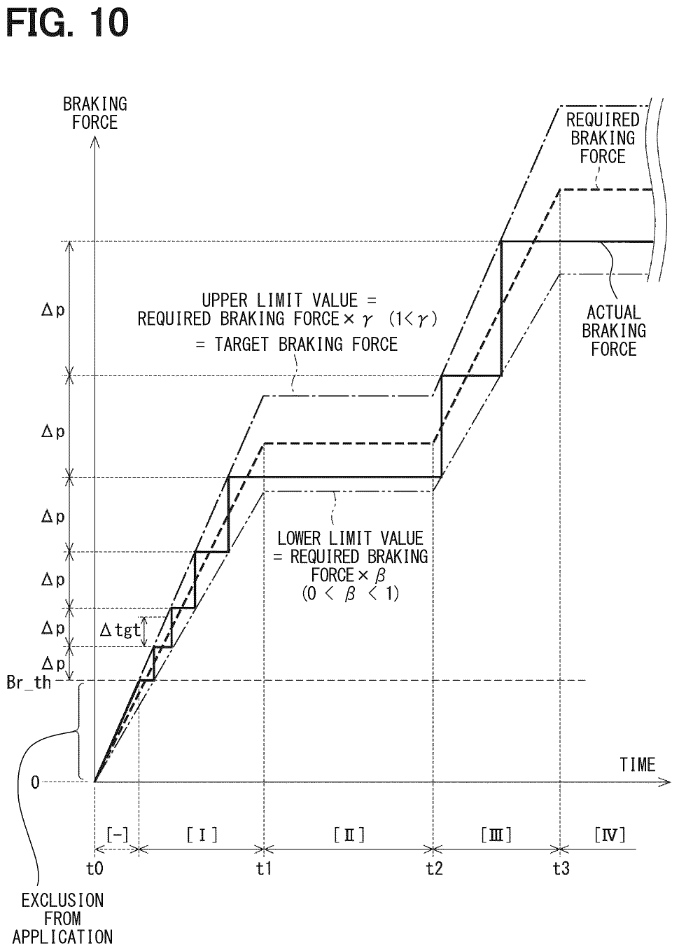

In the fourth embodiment shown in FIG. 10, the braking force controller 40 sets the upper limit value and the lower limit value with a difference corresponding to the target difference threshold Δp of the required braking force correlation formula, up or down across the required braking force. As in the third embodiment, the braking force controller 40 controls the actual braking force between the lower limit value and the upper limit value with the upper limit value as the target braking force.

When the target difference threshold Δp is proportional to the required braking force, 0<β<1 and 1<y, the lower limit value is calculated by “required braking force*β” and the upper limit value is calculated by “required braking force*γ”. When “γ−β=1−α” relative to a proportionality constant α in FIG. 8, the upper limit value and the lower limit value in FIG. 10 have a difference corresponding to the target difference threshold Δp in FIG. 8. When “β+γ=2”, the upper and lower limit values are set equally above and below the required braking force.

### Fifth Embodiment

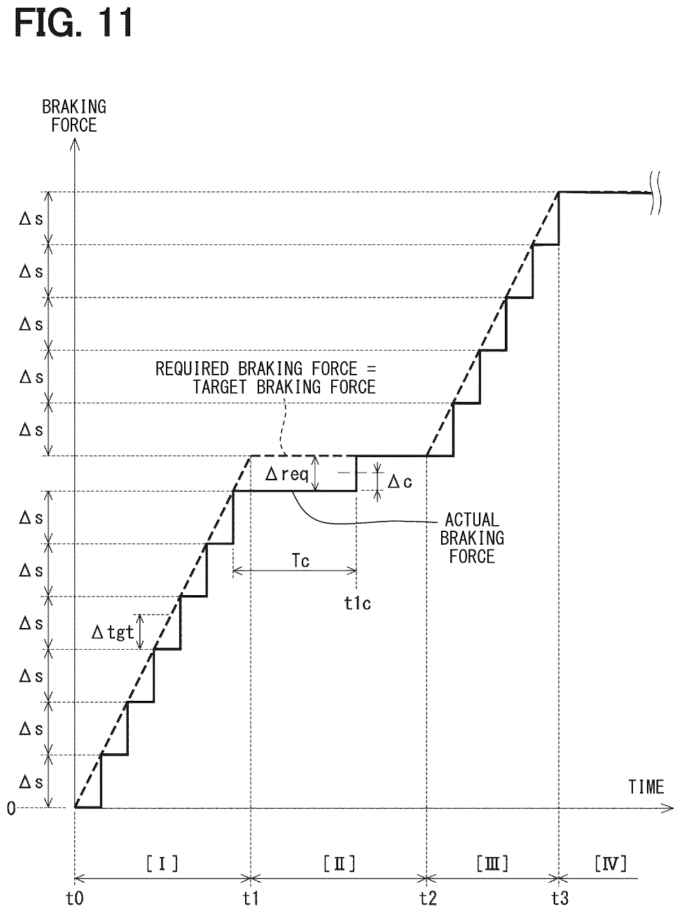

In fifth and sixth embodiments, a difference between the actual braking force and the required braking force is defined as “required difference Δreq”. The fifth embodiment shown in FIG. 11 differs from the first embodiment in FIG. 5 in a switching configuration in section [II]. Since the required braking force is constant in section [II], the required difference Δreq in the holding period that started immediately before interval [II] is also constant. When section [II] continues for a long time, braking force deviation due to the required difference Δreq will remain for a long time.

Therefore, the braking force controller 40 stops holding the actual braking force and makes the actual braking force match the required braking force when the required difference Δreq at a time point t1c when the holding period has elapsed for a specified duration Tc is greater than the required difference threshold Δc. The required difference threshold Δc is set to a value smaller than the target difference threshold Δs. Since the target braking force is equal to the required braking force in the fifth embodiment, the actual braking force also appears to be equal to the target braking force. Symbols “Tc” and “Δc” are derived from ‘continue’. As a result, the braking force deviation that persists over a longer period of time can be avoided.

The required braking force increases again when moving from section [II] to section [III]. In an example shown in FIG. 11, the actual braking force before the elapsed time point t1c of duration Tc is reset, and the target difference threshold Δs is reset based on the actual braking force at a start of section [III]. Thereafter, the target braking force is switched from the holding period to the increasing period every time the target difference Δtgt reaches the target difference threshold Δs in section [III].

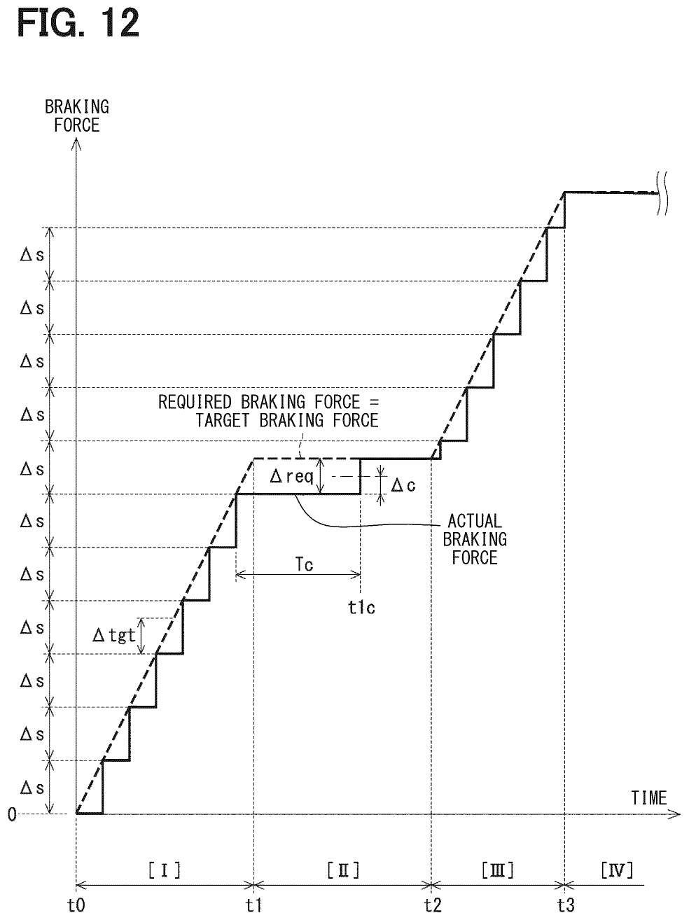

On the other hand, in a modification of the fifth embodiment shown in FIG. 12, the actual braking force before the elapsed time point t1c of duration Tc is stored, and the target difference threshold Δs based on the previous actual braking force is used even after the start of section [III]. Thus, a method of resuming the switching process after the elapse of the duration time Tc may be set as appropriate.

### Sixth Embodiment

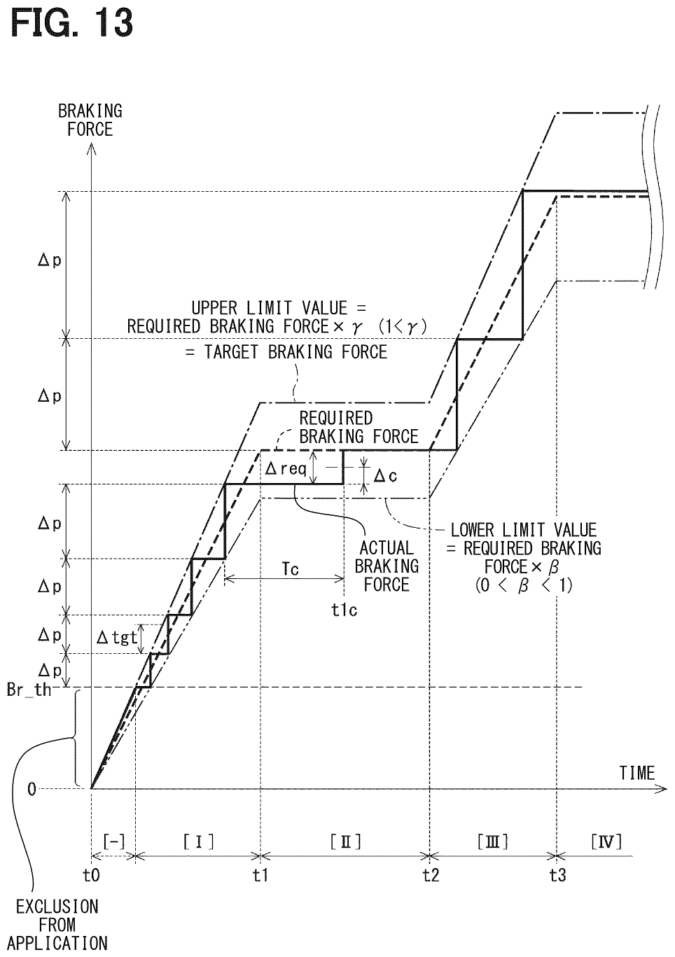

A sixth embodiment shown in FIG. 13 applies suspension of holding the actual braking force at the elapse of duration Tc to the fourth embodiment that uses the upper and lower limit values. In section [II], the braking force controller 40 stops holding the actual braking force and makes the actual braking force match the required braking force when the required difference Δreq at a time point t1c when the holding period has elapsed for a specified duration Tc is greater than the required difference threshold Δc. The required difference threshold Δc is set to a value smaller than the target difference threshold Δp. In the sixth embodiment, it is clear that a control aim value of the actual braking force is the required braking force.

The required braking force increases again when moving from section [II] to section [III]. In an example shown in FIG. 13, the actual braking force before the elapsed time point t1c of duration Tc is reset and the target difference threshold Δp is reset. In addition to this example, the target difference threshold Δp based on the previous actual braking force may be used, as in the modification of the fifth embodiment.

### Other Embodiments

The vehicle on which the vehicle braking device of the present disclosure is mounted is not limited to a four-wheel vehicle having two rows of left and right wheels in the vehicle front-rear direction, and may be a vehicle having six or more wheels having three or more rows of wheels in the vehicle front-rear direction.

In the above embodiment, the switching process for the electric brakes 61 to 64 corresponding to each wheel 91 to 94 is described as independent. However, processes may be implemented so that, for example, a switching method, threshold, etc., of a switching process for front wheels 91, 92 and a switching process for rear wheels 93 and 94 may be differentiated or interlocked with each other.

The application exclusion requirement may include cases where it is assumed that the required braking force is unlikely to increase rapidly due to road conditions, weather, or other factors. For example, it may be determined that braking is more conducive when driving on an uneven road surface or when there is a strong headwind, and thus the application exclusion requirement is met.

The present disclosure should not be limited to the embodiment described above. Various other embodiments may be implemented without departing from the scope of the present disclosure.

The disclosures about the braking force control unit may be combined with each of the disclosures about the vehicle braking device for which control by the braking force control unit is identified.

The braking force controller and method described in the present disclosure may be implemented by a special purpose computer which is configured with a memory and a processor programmed to execute one or more particular functions embodied in computer programs of the memory. Alternatively, the braking force controller described in the present disclosure and the method thereof may be realized by a dedicated computer configured as a processor with one or more dedicated hardware logic circuits. Alternatively, the braking force controller and method described in the present disclosure may be realized by one or more dedicated computer, which is configured as a combination of a processor and a memory, which are programmed to perform one or more functions, and a processor which is configured with one or more hardware logic circuits. Furthermore, the computer program may be stored in a computer-readable non-transitory tangible storage medium as an instruction executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle braking device for a vehicle having electric brakes, which are provided on respective wheels and generating braking force on the corresponding wheels, the vehicle braking device comprising
a braking force controller configured to control braking forces generated by the electric brakes based on a required braking force commanded from an outside, wherein
a relationship between an electric current and the braking force in each of the electric brakes has a hysteresis characteristics,
the hysteresis characteristics indicates that the braking force increases along a positive efficiency line when the electric current increases, the braking force is held constant when the electric current decreases from a turning value at which the electric current changes from increasing to decreasing to a holding threshold, and the braking force decreases along an inverse efficiency line when the electric current decreases from the holding threshold,
a period during which an actual braking force, which is the braking force actually output by the electric brake, is increased along the positive efficiency line is an increasing period,
a period during which the actual braking force is held constant while the current is decreased from the turning value to the holding threshold is a holding period, and
under a condition that the vehicle does not meet an application exclusion requirement and that the required braking force is increasing, the braking force controller is configured to:
switch from the increasing period to the holding period when the actual braking force increases and reaches a target braking force, which is set based on the required braking force; and
switch from the holding period to the increasing period when a target difference between the actual braking force and the target braking force reaches a predetermined target difference threshold.

2. The vehicle braking device according to claim 1, wherein
the braking force controller is configured to control energization of each of the electric brake at an operating point on the inverse efficiency line during the holding period.

3. The vehicle braking device according to claim 1, wherein
the target difference threshold is set to a fixed value.

4. The vehicle braking device according to claim 1, wherein
the target difference threshold is set to a value that correlates to the current required braking force.

5. The vehicle braking device according to claim 3, wherein
the braking force controller is configured to:
set an upper limit value and a lower limit value with a difference corresponding to the target difference threshold above and below the required braking force; and
control the actual braking force between the lower limit value and the upper limit value with the upper limit value as the target braking force.

6. The vehicle braking device according to claim 3, wherein
a difference between the actual braking force and the required braking force at a time point when the holding period has elapsed for a predetermined duration is a required difference, and
the braking force controller is configured to stop holding the actual braking force and match the actual braking force with the required braking force when the required difference is equal to or greater than a required difference threshold, which is smaller than the target difference threshold.

7. The vehicle braking device according to claim 1, wherein
the braking force controller is configured to control energization of each of the electric brakes such that the actual braking force follows by the required braking force at each control cycle when at least one of application exclusion requirements is satisfied, and
the application exclusion requirements include:
the required braking force of the vehicle is less than a predetermined braking force threshold;
fluctuation in the required braking force of the vehicle is greater than a predetermined braking force fluctuation threshold;
temperature of each of the electric brakes is less than a predetermined temperature threshold; and
a vehicle speed is greater than a predetermined vehicle speed threshold.

8. A vehicle braking device for a vehicle having electric brakes, which are provided on respective wheels and generating braking force on the corresponding wheels comprising:
at least one processor; and
at least one memory storing computer program code, wherein
the at least one memory and the computer program code are configured, with the at least one processor, to cause the vehicle braking device to carry out:
controlling braking forces generated by the electric brakes based on a required braking force commanded from an outside,
a relationship between an electric current and the braking force in each of the electric brakes has a hysteresis characteristics,
the hysteresis characteristics indicates that the braking force increases along a positive efficiency line when the electric current increases, the braking force is held constant when the electric current decreases from a turning value at which the electric current changes from increasing to decreasing to a holding threshold, and the braking force decreases along an inverse efficiency line when the electric current decreases from the holding threshold,
a period during which an actual braking force, which is the braking force actually output by the electric brake, is increased along the positive efficiency line is an increasing period,
a period during which the actual braking force is held constant while the current is decreased from the turning value to the holding threshold is a holding period, and
under a condition that the vehicle does not meet an application exclusion requirement and that the required braking force is increasing, the at least one memory and the computer program code are configured, with the at least one processor, to cause the vehicle braking device to carry out:
switching from the increasing period to the holding period when the actual braking force increases and reaches a target braking force, which is set based on the required braking force; and
switching from the holding period to the increasing period when a target difference between the actual braking force and the target braking force reaches a predetermined target difference threshold.
